(19) United States
(12) Patent Application Publication
(10) Pub. No.: US 2008/0309234 A1
(43) Pub. Date: Dec. 18, 2008

(54) ALTERNATING CURRENT DRIVING TYPE QUANTUM DOT ELECTROLUMINESCENT DEVICE

(75) Inventors: KYUNG SANG CHO, GWACHEON-SI (KR); BYOUNG LYONG CHOI, SEOUL (KR); SANG JUN CHOI, YONGIN-SI (KR); EUN KYUNG LEE, SUWON-SI (KR)

Correspondence Address: CANTOR COLBURN, LLP, 20 Church Street, 22nd Floor, Hartford, CT, 06103, US

(73) Assignee: SAMSUNG ELECTRONICS CO., LTD., SUWON-SI (KR)

(21) Appl. No.: 11/933,306

(22) Filed: Oct. 31, 2007

(30) Foreign Application Priority Data
Jun. 15, 2007 (KR) 10-2007-0058997

(51) Int. Cl. H01J 1/62

(52) U.S. Cl. 313/509

(57) ABSTRACT

An alternating current driving type quantum dot electroluminescent device includes; a first electrode, a second electrode, a quantum dot light-emitting layer disposed between the first electrode and the second electrode, and at least one layer selected from the group consisting of a tunneling layer, a bipolar layer, a dielectric layer, an insulating layer, and a combination of layers thereof, disposed between at least one of the first electrode and the quantum dot light-emitting layer, and the second electrode and the quantum dot light-emitting layer.

This application claims priority to Korean Patent Application No. 10-2007-0058997, filed on Jun. 15, 2007, and all the benefits accruing therefrom under 35 U.S.C. §119, the contents of which in its entirety are herein incorporated by reference.

### BACKGROUND OF THE INVENTION

1. Field of the invention

The present invention relates to an alternating current (“AC”) driving type quantum dot electroluminescent (“EL”) device.

2. Description of the Related Art

An electroluminescent (“EL”) device is a device that utilizes the phenomenon by which light is emitted when an electric field is applied to a predetermined material. The electric field injects electrons and imaginary particles called holes into the predetermined material. When the electrons and holes are combined they form excitons, which, when formed in the light emitting layer, emit light. Recently, many devices that use quantum dots as material for the light-emitting layer have been developed.

Quantum dots, which are made from a nano-sized semiconductor material, manifest a quantum confinement effect. When the quantum dots receive light from an excitation source and enter an energy excited state, energy corresponding to a difference between an excited state's energy band and a de-excited state's energy band is emitted when the quantum dot is de-excited. This energy difference between an excited and de-excited state is often called an energy band gap. Thus, because the quantum dots enable the control of electrical and optical properties of the materials in which they are embedded through the adjustment of the size of their respective energy band gaps, they may be applied to various devices, including light-receiving devices, light-emitting devices, etc.

Korean Unexamined Patent Publication No. 2006-0100151 discloses a quantum dot light-emitting device combined with a polymer, which has a structure in which a quantum dot active layer is included in an insulating polymer formed between hole and electron injecting electrodes, and which is driven using AC power. US Patent Publication Application No. 2006/0170331 discloses a quantum dot light-emitting device, in which a compressed quantum dot light-emitting layer or a filler material having a smaller particle size is present between hole and electron injecting electrodes, in which the light-emitting layer may be formed through compression at high temperatures, and which may be driven by AC power.

However, in the above described conventional techniques, the excitons, which are produced in the quantum dot light-emitting layer, are easily discharged through the electrode due to the quantum dot light emitting layer being in direct contact with the electrode. This leads to undesirable quenching of the excitons formed in the light-emitting layer, resulting in inefficient light emission.

### BRIEF SUMMARY OF THE INVENTION

Accordingly, exemplary embodiments have been devised keeping in mind the above problems occurring in the related art.

In one exemplary embodiment an alternating current (“AC”) driving type quantum dot electroluminescent (“EL”) device includes; a first electrode, a second electrode, a quantum dot light-emitting layer disposed between the first electrode and the second electrode, and at least one layer selected from the group consisting of a tunneling layer, a bipolar layer, a dielectric layer, an insulating layer and a combination of layers thereof, disposed between at least one of the first electrode and the quantum dot light-emitting layer, and the second electrode and the quantum dot light-emitting layer.

In another exemplary embodiment a display device includes; an AC driving type quantum dot EL device including; a first electrode, a second electrode, a quantum dot light-emitting layer disposed between the first electrode and the second electrode, and at least one layer selected from the group consisting of a tunneling layer, a bipolar layer, a dielectric layer, an insulating layer, and a combination of layers thereof, disposed between at least one of the first electrode and the quantum dot light-emitting layer, and the second electrode and the quantum dot light-emitting layer.

According to another exemplary embodiment, an AC driving type quantum dot EL device, including; a first electrode, a second electrode, a first quantum dot light-emitting layer disposed between the first and second electrodes, a second quantum dot light-emitting layer disposed between the first and second electrodes, an insulating layer disposed between the first quantum dot light-emitting layer and the second quantum dot light-emitting layer, and at least one layer selected from the group consisting of a tunneling layer, a bipolar layer and a dielectric layer or a combination thereof, disposed between at least one of the first electrode and the first quantum dot light-emitting layer, and the second electrode and the second quantum dot light-emitting layer.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a schematic cross-sectional view illustrating a comparative embodiment of an alternating current (“AC”) driving type quantum dot electroluminescent (“EL”);

FIG. 2 is a schematic cross-sectional view illustrating a first exemplary embodiment of an AC driving type quantum dot EL device according to the present invention;

FIG. 3 is a schematic cross-sectional view illustrating a second exemplary embodiment of an AC driving type quantum dot EL device according to the present invention;

FIG. 4 is a schematic cross-sectional view illustrating a third exemplary embodiment of an AC driving type quantum dot EL device according to the present invention;

FIG. 5 is a schematic cross-sectional view illustrating a fourth exemplary embodiment of an AC driving type quantum dot EL device according to a fourth example embodiment;

FIG. 6 is a schematic cross-sectional view illustrating a fifth exemplary embodiment of an AC driving type quantum dot EL device according to the present invention;

FIG. 7 is a schematic cross-sectional view illustrating a sixth exemplary embodiment of an AC driving type quantum dot EL device according to the present invention;

FIG. 8 is a schematic cross-sectional view illustrating a seventh exemplary embodiment of an AC driving type quantum dot EL device according to the present invention;

FIG. 9 is a schematic cross-sectional view illustrating an eighth exemplary embodiment of an AC driving type quantum dot EL device according to the present invention;

FIG. 10 is a cross-schematic sectional view illustrating a ninth exemplary embodiment of an AC driving type quantum dot EL device according to the present invention;

FIG. 11 is a cross-schematic sectional view illustrating a tenth exemplary embodiment of an AC driving type quantum dot EL device according to the present invention;

FIG. 12 is a schematic cross-sectional view illustrating an eleventh exemplary embodiment of an AC driving type quantum dot EL device according to the present invention; and

FIG. 13 is a schematic cross-sectional view illustrating a twelfth exemplary embodiment of an AC driving type quantum dot EL device according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in more detail with reference to the accompanying drawings.

Hereinafter, a detailed description of the exemplary embodiments will be given with reference to the appended drawings.

According to one exemplary embodiment, an alternating current (“AC”) driving type quantum dot electroluminescent (“EL”) device having a quantum dot light-emitting layer disposed between a first electrode and a second electrode, may further include at least one layer selected from among a tunneling layer, a bipolar layer, a dielectric layer and an insulating layer or a combination thereof disposed between the first electrode and the quantum dot light-emitting layer and/or the second electrode and the quantum dot light-emitting layer.

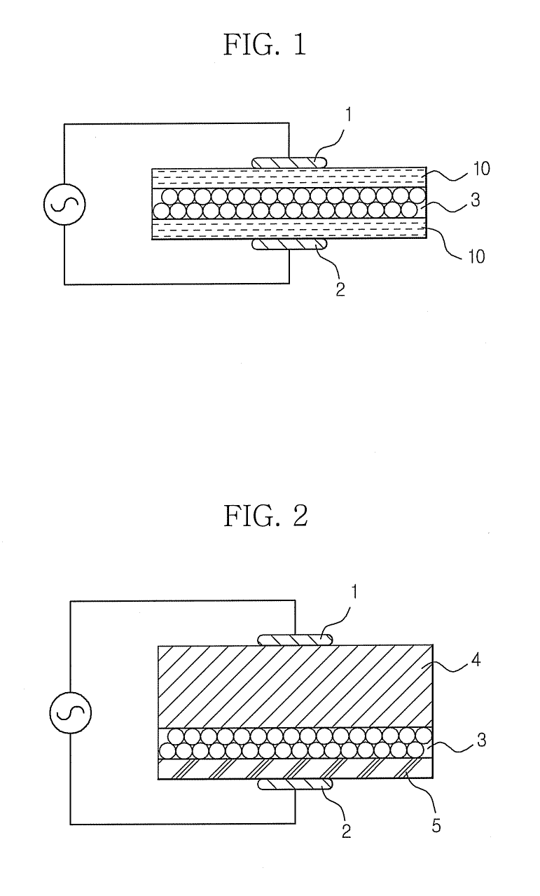

FIG. 1 illustrates a universal embodiment of an AC driving type quantum dot EL device. With reference to FIG. 1, an AC driving type quantum dot EL device according to the universal embodiment may include a quantum dot light-emitting layer 3 disposed between a first electrode 1 and a second electrode 2. In addition an electrical/optical property modifying layer 10, which is composed of a layer selected from among a tunneling layer, a bipolar layer, a dielectric layer and an insulating layer, or a combination thereof, may be provided between the first electrode 1 and the quantum dot light-emitting layer 3 and/or between the second electrode 2 and the quantum dot light-emitting layer 3. In the universal embodiment shown in FIG. 1, the property modifying layer 10 is disposed between the quantum dot light-emitting layer 3 and both the first and second electrodes 1 and 2, respectively.

Because the device utilizes AC power, each of the first and second electrodes, 1 and 2, respectively, are capable of functioning as both a cathode, which injects electrons, and an anode, which injects holes depending on the state of the alternating voltage. At one point in the alternating cycle, electrode 1 will become the anode and electrode 2 will become the cathode, and at the opposite phase of the cycle, electrode 1 will become the cathode, and electrode 2 will become the anode. In such a device, the electrons and holes may be injected into the quantum dot light-emitting layer 3 from both sides of the device over one voltage cycle. A low efficiency of combination of holes and electrons to thereby form excitons in the quantum dot light-emitting layer 3 is caused due to differences in mobility between holes and electrons through the property modifying layer 10.

Specific configurations of the universal embodiment of the invention will be described in more detail below with respect to the individual exemplary embodiments.

As illustrated in FIGS. 2 to 6, first to fifth exemplary embodiments of the AC driving type quantum dot EL device may include an insulating layer 4, disposed either between the quantum dot light-emitting layer 3 and the first electrode 1, or between the quantum dot light-emitting layer 3 and the second electrode 2.

In one exemplary embodiment the first electrode 1 and the second electrode 2 may be formed of a material which facilitates the injection of electrons or holes. In one exemplary embodiment the first electrode 1 and/or the second electrode 2 may be made from a transparent material, exemplary embodiments of which include, but are not limited to, Indium Tin Oxide (“ITO”), Indium Zinc Oxide (“IZO”) or Fluorine-doped Tin Oxide (“FTO”). In another exemplary embodiment the first electrode 1 and/or the second electrode 2 may be made from a metal, exemplary embodiments of which include, but are not limited to, Al, Au, Ag, In, Sn, Mg, Ca, Pt, Ba, Ni, or a combination thereof.

In the exemplary embodiment of an AC driving type quantum dot EL device according to present invention, the quantum dot light-emitting layer 3 is formed using quantum dots as a light-emitting material. Such quantum dots may exhibit light emission efficiency and color purity superior to phosphors used for conventional inorganic EL devices. Furthermore, although the phosphors of the conventional inorganic EL device have a non-uniform size distribution in the range from hundreds of nanometers to tens of millimeters, in the present exemplary embodiments the quantum dots are nanometer-sized particles (in one exemplary embodiment they are about 5 nm in diameter) and the quantum dot light-emitting layer may be formed to a thickness corresponding to one-thousandth or less of the thickness of the conventional phosphor layer. This decreased separation across the light emitting layer thus makes it possible to decrease the driving voltage of the device.

In the exemplary embodiments of an AC driving type quantum dot EL device according to the present invention, examples of material for the quantum dot light-emitting layer 3 include, but are not limited to, Group II-VI compound semiconductor nanocrystals, Group III-V compound semiconductor nanocrystals, Group IV-VI compound semiconductor nanocrystals, Group IV compound semiconductor nanocrystals, and combinations thereof, wherein the group numbers correspond to the numbering system adopted by the International Union of Pure and Applied Chemistry (“IUPAC”).

Exemplary embodiments of the Group II-VI compound semiconductor nanocrystals include, but are not limited to, binary compounds thereof, including CdSe, CdTe, ZnS, ZnSe and ZnTe, ternary compounds thereof, including CdSeS, CdSeTe, CdSTe, ZnSeS, ZnSeTe, ZnSTe, CdZnS, CdZnSe and CdZnTe, and quaternary compounds thereof, including CdZnSeS, CdZnSeTe, CdZnSTe, CdHgSeS, CdHgSeTe, CdHgSTe, HgZnSeS, HgZnSeTe and HgZnSTe.

Exemplary embodiments of the Group III-V compound semiconductor nanocrystals include, but are not limited to, binary compounds thereof, including GaN, GaP, GaAs, GaSb, InP, InAs and InSb, ternary compounds thereof, including GaNP, GaNAs, GaNSb, GaPAs, GaPSb, InNP, InNAs, InNSb, InPAs, InPSb and GaAlNP, and quaternary compounds thereof, including GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs and InAlPSb.

Exemplary embodiments of the Group IV-VI compound semiconductor nanocrystals include, but are not limited to, binary compounds thereof, including PbS, PbSe and PbTe, ternary compounds thereof, including PbSeS, PbSeTe, PbSTe, SnPbS, SnPbSe and SnPbTe, and quaternary compounds thereof, including SnPbSSe, SnPbSeTe and SnPbSTe.

Exemplary embodiments of the Group IV compound semiconductor nanocrystals include, but are not limited to, unary compounds thereof, including Si and Ge, and binary compounds thereof, including SiC and SiGe.

In one exemplary embodiment, the thickness of the quantum dot light-emitting layer 3 ranges from about 3 nm to about 100 nm, but the present invention is not limited thereto.

As illustrated in FIG. 2, a first exemplary embodiment of an AC driving type quantum dot EL device may include an insulating layer 4 disposed between the quantum dot light-emitting layer 3 and the first electrode 1 and a tunneling layer 5 disposed between the quantum dot light-emitting layer 3 and the second electrode 2.

When voltage is applied between the first electrode 1 and the second electrode 2 of the first exemplary embodiment of an AC driving type quantum dot EL device having the above structure, electrons or holes are not transported through the insulating layer 4, and electrons (or holes) are therefore only injected from the second electrode 2 to the quantum dot light-emitting layer 3 by an electric field produced at both sides of the tunneling layer 5.

The tunneling layer 5 is configured in such a way that it is easy for charge carriers, e.g., holes and electrons, to pass through it in one direction, but not in the opposite direction. The electrons (or holes) thus injected are prevented from being back-transported to the second electrode 2 by the tunneling layer 5, and remain in the quantum dot light-emitting layer 3 or at the interface of the quantum dot light-emitting layer 3 and the tunneling layer 5.

When holes (or alternatively, electrons, which are oppositely charged carriers) are injected via an AC driving method, they are recombined with the existing electrons (or alternatively, holes) already present in the quantum dot light-emitting material, thus forming excitons, which emit light corresponding to the band gap of the quantum dot light-emitting layer 3. The magnitude of light emitted from the device having the above structure may be controlled by controlling the frequency and amplitude of AC voltage applied across the two electrodes. Essentially, the insulating layer 4 and the tunneling layer 5 improve the balance between the number of holes and electrons in the quantum dot light-emitting layer 3, and thereby increase the light-emitting efficiency of the EL device.

Although exemplary embodiments of methods of manufacturing the first exemplary embodiment of an AC driving type quantum dot EL device according to the present invention are not particularly limited, one exemplary embodiment may be illustratively conducted as follows.

An insulating material, exemplary embodiments of which include metal oxide, is deposited in the form of a thin film on a substrate coated with a conductive material, the conductive material forming a first electrode 1 and the insulating material forming an insulating layer 4. In one exemplary embodiment the insulating material is deposited through e-beam evaporation. Subsequently, semiconductor nanocrystals, exemplary embodiments of which include CdSe/ZnS, are spin coated on the insulating layer 4, thus forming a quantum dot light-emitting layer 3. A predetermined material, exemplary embodiments of which include MgO, may be deposited through e-beam evaporation on the quantum dot light-emitting layer 3, or alternatively, a polymer, exemplary embodiments of which include polymethylmethacrylate (“PMMA”), may be applied through spin coating, thus forming a tunneling layer 5. After forming the tunneling layer 5, a metal, exemplary embodiments of which include aluminum, is deposited on the tunneling layer 5, thereby forming a second electrode 2. Thereby an exemplary embodiment of an AC driving type quantum dot EL device may be manufactured.

In one exemplary embodiment the tunneling layer 5 may be formed through a liquid-phase process, exemplary embodiments of which include spin coating, spray coating, dip coating, casting or printing, however, the present invention is not limited thereto. In order to conduct a liquid-phase process, in particular, spin coating, crosslinking of the quantum dot light-emitting layer 3 using a crosslinking agent, exemplary embodiments of which include hydrazine, dithiol or diamine, may be further performed.

In the exemplary embodiments of an AC driving type quantum dot EL device according to the present invention, the insulating layer 4 may be formed of any insulating material as commonly known in the art, and in one exemplary embodiment the insulating layer 4 may be an inorganic insulating material, exemplary embodiments of which include, but are not limited to, SiO₂, LiF, BaF₂, TiO₂, ZnO, SiC, SnO₂, WO₃, ZrO₂, HfO₂, Ta₂O₅, BaTiO₃, BaZrO₃, Al₂O₃, Y₂O₃, ZrSiO₄, Si₃N₄, TiN and combinations thereof.

Alternative exemplary embodiments include configurations wherein, the insulating layer 4 may be formed of an organic insulating material, exemplary embodiments of which include, but are not limited to, polymers, including epoxy resin and phenol resin, fatty acid monomers, including 3-(4-biphenylyl)-4-phenyl-5-tert-butylphenyl-1,2,4-triazole (TAZ), 3,4,5-triphenyl-1,2,4-triazole, 3,5-bis(4-tert-butylphenyl)-4-phenyl-1,2,4-triazole, arachidic acid and stearic acid, and combinations thereof.

In one exemplary embodiment the thickness of the insulating layer 4 may range from about 10 nm to about 500 nm. If the insulating layer 4 is thinner than about 10 nm, the efficacy of the insulating layer 4 as a barrier for blocking the transport of electrons or holes may be reduced. On the other hand, if the insulating layer is thicker than about 500 nm, the overall thickness of the device is considerably increased, making it difficult to realize high efficiency at low voltage.

In the exemplary embodiments of an AC driving type quantum dot EL device according to the present invention, exemplary embodiments of the tunneling layer 5 may be formed of inorganic insulating materials, exemplary embodiments of which include SiO₂, MgO, or HfO₂, and polymers, an exemplary embodiment of which is polymethylmethacrylate (“PMMA”).

In one exemplary embodiment, the thickness of the tunneling layer 5 may range from about 1 nm to about 10 nm. If the tunneling layer 5 is thinner than about 1 nm, back-transport of the electrons or holes injected into the inner portion of the device, or the quenching of excitons, may occur. On the other hand, if the tunneling layer 5 is thicker than about 10 nm, it becomes difficult to exhibit a tunneling effect for directly transporting electrons or holes.

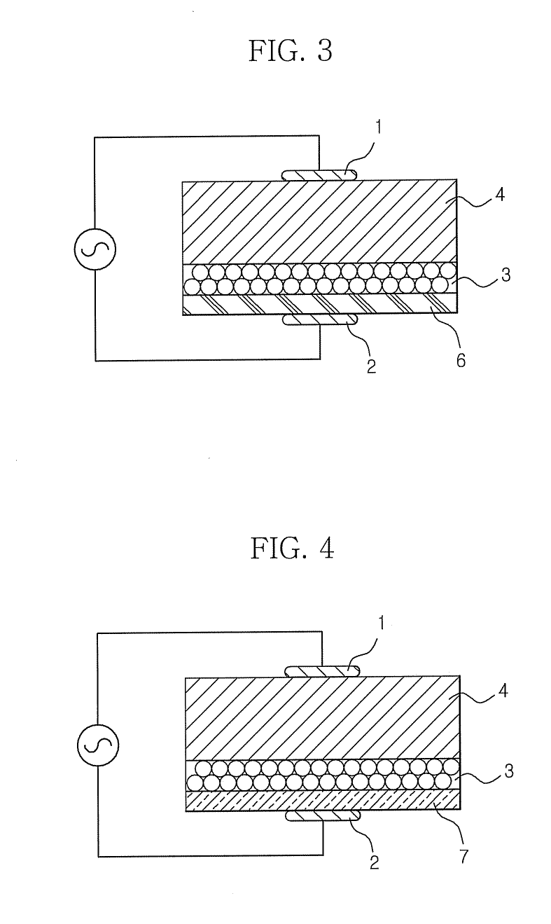

As illustrated in FIG. 3, a second exemplary embodiment of an AC driving type quantum dot EL device according to the present invention may include an insulating layer 4 disposed between the quantum dot light-emitting layer 3 and the first electrode 1 and a bipolar layer 6 disposed between the quantum dot light-emitting layer 3 and the second electrode 2.

The bipolar layer 6 enables the transport of both electrons and holes. Thus, when voltage is applied, electrons and holes are injected from the second electrode 2 to the quantum dot light-emitting layer 3. Again, because the device utilizes AC power, the second electrode 2 functions as both a cathode, which injects electrons, and an anode, which injects holes depending on the state of the alternating voltage. When opposite charges are injected through AC power and recombined excitons are formed, thus emitting light.

Although exemplary embodiments of methods of manufacturing the second exemplary embodiment of an AC driving type quantum dot EL device according to the present invention are not particularly limited, one exemplary embodiment may be illustratively conducted as follows.

Using substantially the same method as in the first exemplary embodiment, an insulating layer 4 and a quantum dot light-emitting layer 3 are sequentially formed on a first electrode 1, after which, a material, may be applied on the quantum dot light-emitting layer 3 thus forming a bipolar layer 6. In one exemplary embodiment the material used to form the bipolar layer 6 may include copper phthalocyanine and may be deposited on the quantum dot light-emitting layer 3 through thermal evaporation. In another exemplary embodiment the material used to form the bipolar layer 6 may include a polymer, exemplary embodiments of which include polyaniline, and may be deposited on the quantum dot light-emitting layer 3 through spin coating. Thereafter, a metal, exemplary embodiments of which include aluminum, is deposited on the bipolar layer 6, thereby forming a second electrode 2. Thereby completing the manufacture of the second exemplary embodiment of an AC driving type quantum dot EL device according to the present invention.

In the exemplary embodiments of an AC driving type quantum dot EL device the bipolar layer 6 may be formed of a predetermined material, exemplary embodiments of which include, but are not limited to, ambipolar monomers, exemplary embodiments of which include copper phthalocyanine, polymers, exemplary embodiments of which include polyaniline, inorganic films, p-n alloys, and p-n mixed films.

As illustrated in FIG. 4, the third exemplary embodiment of an AC driving type quantum dot EL device according to the present invention may include an insulating layer 4 disposed between the quantum dot light-emitting layer 3 and the first electrode 1, and a dielectric layer 7 disposed between the quantum dot light-emitting layer 3 and the second electrode 2.

In the third exemplary embodiment having the dielectric layer 7 as mentioned above, when a positive (+) voltage is applied to the second electrode 2, dipoles of the dielectric layer 7 are oriented in the direction of the electric field, and the side of the second electrode 2 is electrically charged to have a positive (+) charge by the oriented dipoles. The positive (+) particles thus oriented are injected to the quantum dot light-emitting layer 3 from the surface of the dielectric layer 7 due to the strong electric field between the first and second electrodes 1 and 2, respectively. While the above effect has been described with respect to the positive particles, one skilled in the art would realize that a similar effect occurs when the electric field is reversed, wherein negatively (−) charged particles become oriented by the dielectric layer and are then injected to the quantum dot light-emitting layer 3 from the surface of the dielectric layer 7.

Alternatively, injection of charges into the quantum dot light-emitting layer may be realized by the orientation of carriers from the dielectric layer 7, in place of the direct injection of carriers from the outside, e.g., the charge carriers do not have to travel from the electrode 2, but rather are directly injected from the dielectric layer 7. In the case where the opposite voltage is alternatingly applied, as in a device using an AC voltage source, the injected electrons or holes are brought into contact with their corresponding opposite charges oriented from the surface of the dielectric layer 7, thus forming excitons within the quantum dot light-emitting layer 3, resulting in light emission.

Although exemplary embodiments of methods of manufacturing the third exemplary embodiment of an AC driving type quantum dot EL device according to the present invention are not particularly limited, one exemplary embodiment may be illustratively conducted as follows.

Using substantially the same method as in the first exemplary embodiment, an insulating layer 4 and a quantum dot light-emitting layer 3 are sequentially formed on a first electrode 1. Then, a material may be deposited on the quantum dot light-emitting layer 3, thus forming a dielectric layer 7. In one exemplary embodiment the material may include Ta₂O₅, and may be deposited through e-beam evaporation onto the quantum dot light-emitting layer 3 to form the dielectric layer 7. In another exemplary embodiment the material may include a TiO₂ sol-gel precursor and may be subjected to spin coating and annealing to form the dielectric layer 7. Thereafter, a metal, exemplary embodiments of which include aluminum, is deposited on the dielectric layer 7 to form a second electrode 2, thus manufacturing a third exemplary embodiment of an AC driving type quantum dot EL device.

In the exemplary embodiments of an AC driving type quantum dot EL device according to the present invention, the dielectric layer 7 may be formed of a predetermined material, exemplary embodiments of which include, but are not limited to, Ta₂O₅, TiO₂, Al₂O₃ and Y₂O₃,and combinations thereof.

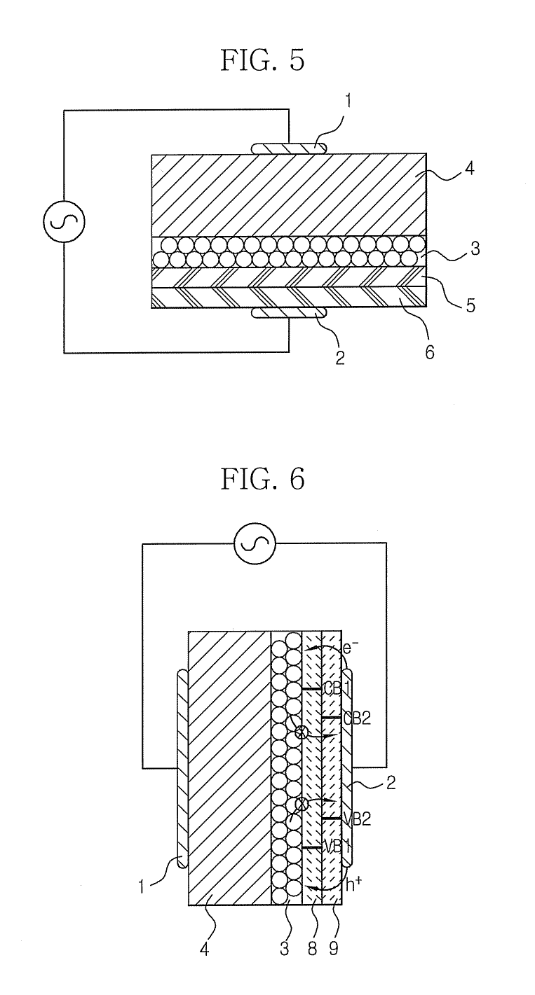

As illustrated in FIG. 5, a fourth exemplary embodiment of an AC driving type quantum dot EL device includes an insulating layer 4 disposed between the quantum dot light-emitting layer 3 and the first electrode 1, and a tunneling layer 5 and a bipolar layer 6 disposed between the quantum dot light-emitting layer 3 and the second electrode 2, in which the tunneling layer 5 is formed adjacent to the quantum dot light-emitting layer 3.

As described above, the tunneling layer 5 is formed inward from the bipolar layer 6 and may decrease the back-transport of electrons or holes which are injected into the quantum dot light-emitting layer 3, which, in the fourth exemplary embodiment, are injected via the above combination structure, through the tunneling layer 5, thereby further improving the efficiency of the device. That is, the tunneling layer 5 effectively separates the quantum dot light-emitting layer 3 from the second electrode 2, and thus, quenching of the excitons outside of the quantum dot light-emitting layer 3 may be prevented, leading to increased light emission efficiency.

As illustrated in FIG. 6, a fifth exemplary embodiment of the AC driving type quantum dot EL device according to the present invention may include an insulating layer 4 disposed between the quantum dot light-emitting layer 3 and the first electrode 1, and a first bipolar layer 8 and a second bipolar layer 9, having band gaps different from each other, disposed between the quantum dot light-emitting layer 3 and the second electrode 2, in which the first bipolar layer 8, having a larger band gap, is formed adjacent to the quantum dot light-emitting layer 3. This sequential increase in band gaps allows for the relatively easy flow of charge carriers from the second bipolar layer 9, having the smaller band gap, to the first bipolar layer 8 and then on to the quantum dot light-emitting layer 3. However, due to the band gap disparities between the first and second bipolar layers 8 and 9, the backflow of charge carriers to the second electrode 2 is effectively prevented.

Although exemplary embodiments of methods of manufacturing the fifth exemplary embodiment of an AC driving type quantum dot EL device according to the present invention are not particularly limited, one exemplary embodiment may be illustratively conducted as follows.

Using substantially the same method as in the first exemplary embodiment, an insulating layer 4 and a quantum dot light-emitting layer 3 are sequentially formed on a first electrode 1. Subsequently, a material, one exemplary embodiment of which is ZnS/CdS, is deposited in the form of a thin film on the quantum dot light-emitting layer 3, then slight p-doping is conducted, and thus two bipolar layers, for example, a first bipolar layer 8 and a second bipolar layer 9, are formed through deposition, exemplary embodiments of the deposition method including CVD or e-beam evaporation. Subsequently, a metal, exemplary embodiments of which include aluminum, is deposited on the second bipolar layer 9, thus manufacturing a fifth exemplary embodiment of an AC driving type quantum dot EL device according to the present invention.

The materials for the first bipolar layer 8 and the second bipolar layer 9 are composed of a relatively high band-gap material and a relatively low band-gap material, respectively, exemplary embodiments of which include, but are not limited to, pentacene/MoO₃, and polyaniline/copper phthalocyanine, respectively.

The structure of the fifth exemplary embodiment of an AC driving type quantum dot EL device having the two bipolar layers as mentioned above is configured such that the two bipolar layers are arranged with decreasing band gaps from the quantum dot light-emitting layer 3 because the valence band (“VB1”) of the first bipolar layer 8 is smaller than the valence band (“VB2”) of the second bipolar layer 9 and the conduction band (“CB1”) of the first bipolar layer 8 is larger than the conduction band (“CB2”) of the second bipolar layer 9.

Due to the above described valence band and band gap arrangement, the electrons or holes are likely to be injected sequentially depending on the stepped energy level of the bipolar layer. However, the electrons injected into the quantum dot light-emitting layer 3 are blocked from moving backwards toward the second electrode 2 by the high energy barrier of the first bipolar layer 8, adjacent to the light-emitting layer, thus preventing the back-transport of the charges. Because more electrons are trapped in the quantum dot light-emitting layer 3, more excitons may be formed in that region, ultimately increasing light emission efficiency.

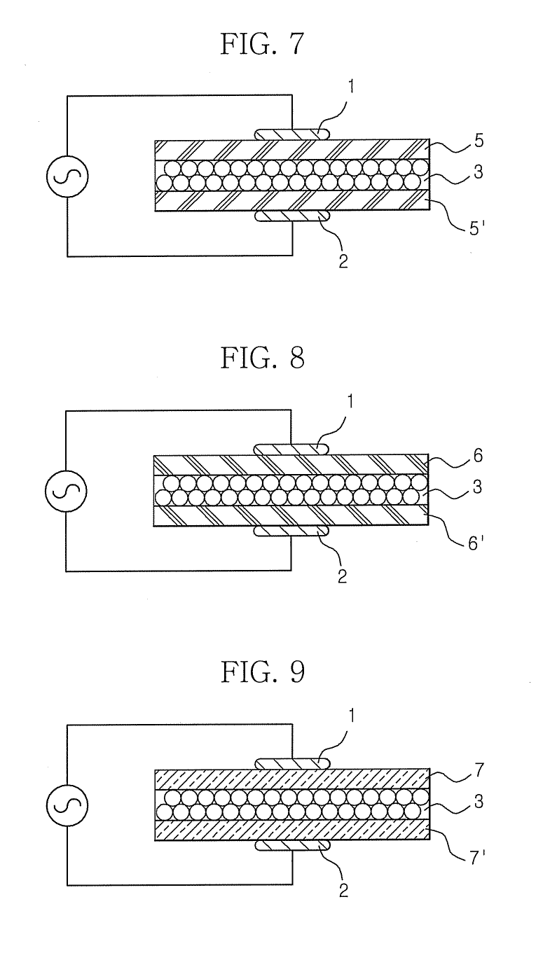

As illustrated in FIG. 7, a sixth exemplary embodiment of an AC driving type quantum dot EL device according to the present invention may include tunneling layers 5 and 5′, disposed between the quantum dot light-emitting layer 3 and the first electrode 1 and between the quantum dot light-emitting layer 3 and the second electrode 2, respectively.

In such an exemplary embodiment, because the electrons and holes may be simultaneously injected from both ends of the device, e.g., they are not prevented from being injected from the first electrode 1 by an insulating layer, it is possible to inject more electrons and holes through a single driving operation, therefore improving light-emitting efficiency and power efficiency.

As illustrated in FIG. 8, a seventh exemplary embodiment of the AC driving type quantum dot EL device according to the present invention may include bipolar layers 6 and 6′ disposed between the quantum dot light-emitting layer 3 and the first electrode 1 and between the quantum dot light-emitting layer 3 and the second electrode 2, respectively.

As described above with respect to the sixth exemplary embodiment, the electrons and holes may be simultaneously injected from both ends of the device, and as well, a thick insulating layer is not needed, whereby voltage required for the injection of the electrons and holes may be decreased, leading to increased power efficiency.

As illustrated in FIG. 9, an eighth exemplary embodiment of the AC driving type quantum dot EL device according to the present invention may include dielectric layers 7 and 7′ disposed between the quantum dot light-emitting layer 3 and the first electrode 1 and between the quantum dot light-emitting layer 3 and the second electrode 2, respectively.

In the current exemplary embodiment, charged particles may be simultaneously oriented by the dielectric layers from both ends of the device, thus improving the light emission efficiency of the device.

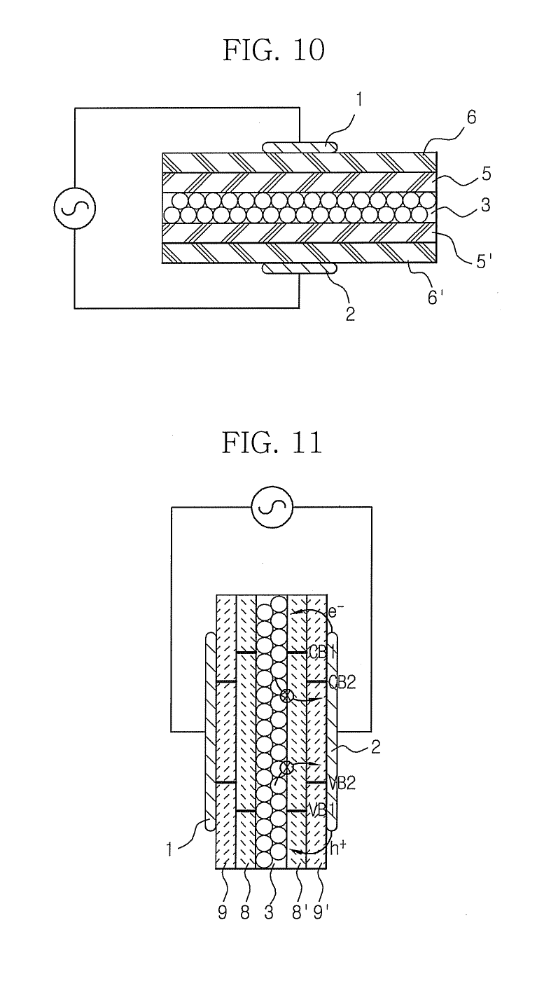

As illustrated in FIG. 10, a ninth exemplary embodiment of an AC driving type quantum dot EL device according to the present invention may include tunneling layers 5 and 5′ and bipolar layers 6 and 6′, respectively, wherein the tunneling layer 5 and the bipolar layer 6 are disposed between the quantum dot light-emitting layer 3 and the first electrode 1 and the tunneling layer 5′ and the bipolar layer 6′ are disposed between the quantum dot light-emitting layer 3 and the second electrode 2. In such an exemplary embodiment the tunneling layers 5 and 5′ are formed adjacent to the quantum dot light-emitting layer 3.

In the ninth exemplary embodiment, electrons and holes may be simultaneously injected from both ends of the device, thus increasing the light-emitting efficiency of the device. In addition, the quenching of the excitons may be prevented by the tunneling layers 5 and 5′ formed adjacent to the quantum dot light-emitting layer 3, also resulting in increased light emission efficiency.

As illustrated in FIG. 11, a tenth exemplary embodiment of an AC driving type quantum dot EL device according to the present invention may include first bipolar layers 8 and 8′ and second bipolar layers 9 and 9′ having band gaps different from each other, respectively, wherein the first and second bipolar layers 8 and 9 are disposed in pairs between the quantum dot light-emitting layer 3 and the first electrode 1 and between the quantum dot light-emitting layer 3 and the second electrode 2. In such an exemplary embodiment the first bipolar layers 8, 8′, having larger band gaps, are formed adjacent to the quantum dot light-emitting layer 3.

The high energy barrier of the first bipolar layers 8, 8′ having greater band gaps decrease, or effectively prevent, the back-transport of the electrons and holes to the electrodes 1 or 2. Thereby, the driving voltage may be reduced, thus increasing light emission efficiency and power efficiency.

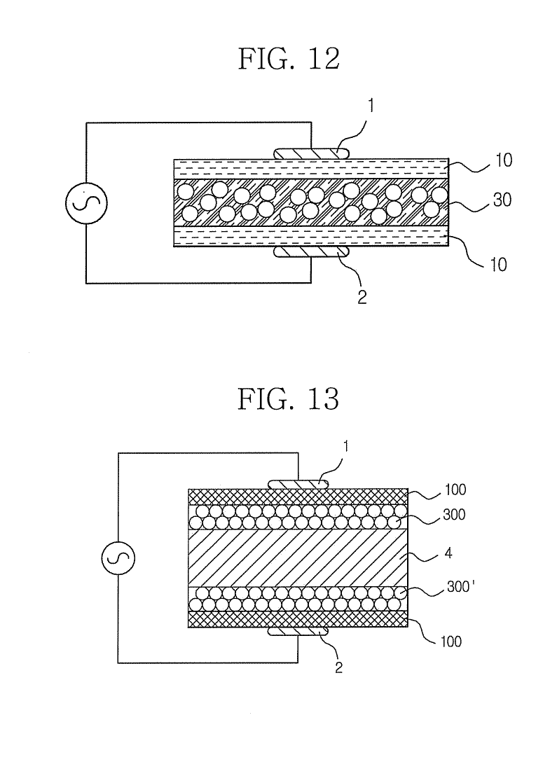

As illustrated in FIG. 12, an eleventh exemplary embodiment of the AC driving type quantum dot EL device according to the present invention may include a light-emitting layer 30 in which quantum dots are embedded in an insulating matrix.

Exemplary embodiments include configurations wherein the light-emitting layer 30 may be composed exclusively of quantum dots, or wherein the light-emitting layer 30 may have a structure in which quantum dots are embedded in an organic or inorganic insulating matrix. Exemplary embodiments of the insulating matrix include, but are not limited to, polymers, exemplary embodiments of which include polymethylmethacrylate (“PMMA”), inorganic precursors, exemplary embodiments of which include magnesium acetate (“Mg(OOCCH₃)₂”) and oxide sol-gel precursors.

Although exemplary embodiments of methods of manufacturing the eleventh exemplary embodiment of an AC driving type quantum dot EL device according to the present invention are not particularly limited, one exemplary embodiment may be illustratively conducted as follows.

An insulating matrix exemplary embodiments of which may be made from a polymer, one exemplary embodiment of which is PMMA, may be mixed with semiconductor nanocrystals, exemplary embodiments of which include CdSe/ZnS, and then the resultant combination may be subjected to spin coating to form the insulation matrix for the light-emitting quantum dots. In an alternative exemplary embodiment, an inorganic precursor, exemplary embodiments of which include magnesium acetate (“Mg(OOCCH₃)₂”), may be mixed with semiconductor nanocrystals, exemplary embodiments of which include CdSe/ZnS, and then the resultant combination may be subjected to spin coating and then annealing to form a quantum dot light-emitting layer 30 having a structure in which the quantum dots are embedded in the insulating matrix. Thereby, the eleventh exemplary embodiment of an AC driving type quantum dot EL device is manufactured according to the present invention.

As illustrated in FIG. 13, a twelfth exemplary embodiment of an AC driving type quantum dot EL device according to the present invention may include a first quantum dot light-emitting layer 300 and a second quantum dot light-emitting layer 300′ with an insulating layer 4 disposed therebetween. The first quantum dot light-emitting layer 300 is disposed adjacent to the insulating layer 4 and a property modifying layer 100, exemplary embodiments of which may include a layer selected from among a tunneling layer, a bipolar layer and a dielectric layer or a combination thereof. The property modifying layer 100 is disposed adjacent to the first electrode 1. The second quantum dot light emitting layer 300′ is disposed substantially opposite the first quantum dot light-emitting layer 300 with respect to the insulating layer 4 and is also disposed adjacent to a property modifying layer 100, which is disposed adjacent to the second electrode 2.

The above described exemplary embodiments of AC driving type quantum dot EL devices according to the present invention may be made of any of the numerous materials as described above, or may be made from any material which may be typically used in the art.

In the current exemplary embodiment, the AC driving type quantum dot EL device has two quantum dot light-emitting layers 300 and 300′, and thus exhibits high brightness and high efficiency properties.

The exemplary embodiments of an AC driving type quantum dot EL device according to the present invention may realize efficient electron injection and full surface emission, and therefore may be usefully applied to electronic devices, including display devices, illumination systems, backlight units, surface emission devices and other devices as may be known to one of ordinary skill in the art.

As described hereinbefore, the exemplary embodiments provide an AC driving type quantum dot EL device. According to the exemplary embodiments, the AC driving type quantum dot EL device has a structure in which one layer, selected from among a tunneling layer, a bipolar layer, a dielectric layer and an insulating layer, or a combination thereof, may be formed between a quantum dot light-emitting layer and either or both of a set of electrodes supplying an electric field to the quantum dot light-emitting layer. Thereby, electrons and holes may be effectively injected into the quantum dot light-emitting layer, and back-transportation of the injected electrons and holes toward the electrode is substantially reduced or effectively eliminated, thus preventing a phenomenon of quenching of excitons formed in the light-emitting layer, resulting in increased light emission efficiency.

Furthermore, exemplary embodiments of the AC driving type quantum dot EL device according to the present invention may exhibit superior light emission efficiency and color purity due to the use of quantum dots as a material for the light-emitting layer, and may have a simple structure because it is driven by AC, making it easy to manufacture the device.

In addition, because the tunneling layer or bipolar layer is formed in a thin film, the driving voltage of the device may be decreased, consequently increasing overall power efficiency. Therefore, exemplary embodiments of the AC driving type quantum dot EL device according to the present invention enable efficient electron injection and full surface emission, and may be usefully applied to electronic devices, including display devices, illumination systems, backlight units, surface emission devices and other devices as commonly known in the art.

Although several exemplary embodiments have been disclosed for illustrative purposes, those skilled in the art will appreciate that various modifications, additions and substitutions are possible, without departing from the scope and spirit of the accompanying claims.

What is claimed is:

1. An alternating current driving type quantum dot electroluminescent device, comprising:
a first electrode;
a second electrode;
a quantum dot light-emitting layer disposed between the first electrode and the second electrode; and
at least one layer selected from the group consisting of a tunneling layer, a bipolar layer, a dielectric layer, an insulating layer and a combination of layers thereof, disposed between at least one of the first electrode and the quantum dot light-emitting layer, and the second electrode and the quantum dot light-emitting layer.

2. The quantum dot electroluminescent device as set forth in claim 1, further comprising an insulating layer disposed between one of the quantum dot light-emitting layer and the first electrode and the quantum dot light-emitting layer and the second electrode.

3. The quantum dot electroluminescent device as set forth in claim 2, wherein the insulating material is selected from a group consisting of SiO₂, LiF, BaF₂, TiO₂, ZnO, SiC, SnO₂, WO₃, ZrO₂, HfO₂, Ta₂O₅, BaTiO₃, BaZrO₃, Al₂O₃, Y₂O₃, ZrSiO₄, Si₃, N₄, TiN and combinations thereof.

4. The quantum dot electroluminescent device as set forth in claim 2, wherein the insulating material is selected from a group consisting of epoxy resin, phenol resin, fatty acid monomers, including 3-(4-biphenylyl)-4-phenyl-5-tert-butylphenyl-1,2,4-triazole (TAZ), 3,4,5-triphenyl-1,2,4-triazole, 3,5-bis(4-tert-butylphenyl)-4-phenyl-1,2,4-triazole, arachidic acid, stearic acid and combinations thereof.

5. The quantum dot electroluminescent device as set forth in claim 2, wherein the insulating layer has a thickness ranging from about 10 nm to about 500 nm.

6. The quantum dot electroluminescent device as set forth in claim 1, further comprising:
an insulating layer disposed between the quantum dot light-emitting layer and the first electrode; and
a tunneling layer disposed between the quantum dot light-emitting layer and the second electrode.

7. The quantum dot electroluminescent device as set forth in claim 1, further comprising:
an insulating layer disposed between the quantum dot light-emitting layer and the first electrode; and
a bipolar layer disposed between the quantum dot light-emitting layer and the second electrode.

8. The quantum dot electroluminescent device as set forth in claim 1, further comprising:
an insulating layer disposed between the quantum dot light-emitting layer and the first electrode; and
a dielectric layer disposed between the quantum dot light-emitting layer and the second electrode.

9. The quantum dot electroluminescent device as set forth in claim 1, further comprising:
an insulating layer disposed between the quantum dot light-emitting layer and the first electrode; and
a tunneling layer and a bipolar layer disposed between the quantum dot light-emitting layer and the second electrode,
wherein the tunneling layer is disposed adjacent to the quantum dot light-emitting layer.

10. The quantum dot electroluminescent device as set forth in claim 1, further comprising:
an insulating layer disposed between the quantum dot light-emitting layer and the first electrode; and
a first bipolar layer and a second bipolar layer, having band gaps different from each other, disposed between the quantum dot light-emitting layer and the second electrode,
wherein the first bipolar layer has a larger band gap and is disposed adjacent to the quantum dot light-emitting layer.

11. The quantum dot electroluminescent device as set forth in claim 1, further comprising:
at least one tunneling layer disposed between the quantum dot light-emitting layer and the first electrode; and
at least one tunneling layer disposed between the quantum dot light-emitting layer and the second electrode.

12. The quantum dot electroluminescent device as set forth in claim 1, further comprising:
at least one bipolar layer disposed between the quantum dot light-emitting layer and the first electrode; and
at least one bipolar layer disposed between the quantum dot light-emitting layer and the second electrode.

13. The quantum dot electroluminescent device as set forth in claim 1, further comprising:
at least one dielectric layer disposed between the quantum dot light-emitting layer and the first electrode; and
at least one dielectric layer disposed between the quantum dot light-emitting layer and the second electrode.

14. The quantum dot electroluminescent device as set forth in claim 1, further comprising:
at least one tunneling layer and at least one bipolar layer disposed between the quantum dot light-emitting layer and the first electrode; and
at least one tunneling layer and at least one bipolar layer disposed between the quantum dot light-emitting layer and the second electrode,
wherein the tunneling layers are formed adjacent to the quantum dot light-emitting layer.

15. The quantum dot electroluminescent device as set forth in claim 1, further comprising:
at least one first bipolar layer and at least one second bipolar layer, wherein the first and second bipolar layers have band gaps different from each other, disposed between the quantum dot light-emitting layer and the first electrode; and
at least one first bipolar layer and at least one second bipolar layer disposed between the quantum dot light-emitting layer and the second electrode,
wherein the first bipolar layers have larger band gaps and are formed adjacent to the quantum dot light-emitting layer.

16. The quantum dot electroluminescent device as set forth in claim 1, wherein the quantum dot light-emitting layer includes quantum dots embedded in an insulating matrix.

17. The quantum dot electroluminescent device as set forth in claim 16, wherein the insulating matrix is selected from a group consisting of polymethylmethacrylate (PMMA), and inorganic precursors, including magnesium acetate (Mg(OOCCH₃)₂) and oxide sol-gel precursors.

18. The quantum dot electroluminescent device as set forth in claim 1, wherein at least one of the first electrode and the second electrode comprises a material selected from a group consisting of indium tin oxide, indium zinc oxide, Fluorine-doped tin oxide, Al, Au, Ag, In, Sn, Mg, Ca, Pt, Ba and Ni.

19. The quantum dot electroluminescent device as set forth in claim 1, wherein the tunneling layer comprises one of an inorganic insulating material selected from a group consisting of SiO₂, MgO, and HfO₂ and polymers, including polymethylmethacrylate.

20. The quantum dot electroluminescent device as set forth in claim 1, wherein the bipolar layer comprises an ambipolar monomer material selected from a group consisting of copper phthalocyanine, polymers, including polyaniline, inorganic films, p-n alloys and p-n mixed films.

21. The quantum dot electroluminescent device as set forth in claim 1, wherein the dielectric layer comprises a material selected from a group consisting of Ta₂O₅, TiO₂, Al₂O₃ and Y₂O₃.

22. The quantum dot electroluminescent device as set forth in claim 1, wherein the quantum dot light-emitting layer comprises quantum dots selected from a group consisting of Group II-VI compound semiconductor nanocrystals, Group III-V compound semiconductor nanocrystals, Group IV-VI compound semiconductor nanocrystals, Group IV compound semiconductor nanocrystals and combinations thereof.

23. The quantum dot electroluminescent device as set forth in claim 22, wherein the Group II-VI compound semiconductor nanocrystals are selected from a group consisting of binary compounds, including CdSe, CdTe, ZnS, ZnSe and ZnTe, ternary compounds, including CdSeS, CdSeTe, CdSTe, ZnSeS, ZnSeTe, ZnSTe, CdZnS, CdZnSe and CdZnTe, and quaternary compounds, including CdZnSeS, CdZnSeTe, CdZnSTe, CdHgSeS, CdHgSeTe, CdHgSTe, HgZnSeS, HgZnSeTe and HgZnSTe, the Group III-V compound semiconductor nanocrystals are selected from a group consisting of binary compounds, including GaN, GaP, GaAs, GaSb, InP, InAs and InSb, ternary compounds, including GaNP, GaNAs, GaNSb, GaPAs, GaPSb, InNP, InNAs, InNSb, InPAs, InPSb and GaAlNP, and quaternary compounds, including GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs and InAlPSb, the Group IV-VI compound semiconductor nanocrystals are selected from a group consisting of binary compounds, including PbS, PbSe and PbTe, ternary compounds, including PbSeS, PbSeTe, PbSTe, SnPbS, SnPbSe and SnPbTe, and quaternary compounds, including SnPbSSe, SnPbSeTe and SnPbSTe, and the Group IV compound semiconductor nanocrystals are selected from a group consisting of unary compounds, including Si and Ge, and binary compounds, including SiC and SiGe.

24. A display device comprising:
an alternating current driving type quantum dot electroluminescent device, comprising:
a first electrode;
a second electrode;
a quantum dot light-emitting layer disposed between the first electrode and the second electrode; and
at least one layer selected from the group consisting of a tunneling layer, a bipolar layer, a dielectric layer, an insulating layer and a combination of layers thereof, disposed between at least one of the first electrode and the quantum dot light-emitting layer, and the second electrode and the quantum dot light-emitting layer.

25. An alternating current driving type quantum dot electroluminescent device, comprising:
a first electrode;
a second electrode;
a first quantum dot light-emitting layer disposed between the first and second electrodes;
a second quantum dot light-emitting layer disposed between the first and second electrodes;
an insulating layer disposed between the first quantum dot light-emitting layer and the second quantum dot light-emitting layer; and
at least one layer selected from the group consisting of a tunneling layer, a bipolar layer, a dielectric layer and a combination thereof, disposed between at least one of the first electrode and the first quantum dot light-emitting layer, and the second electrode and the second quantum dot light-emitting layer.
